(19) United States
(12) Patent Application Publication
(10) Pub. No.: US 2012/0288724 A1
(43) Pub. Date: Nov. 15, 2012

(54) ELECTRONIC COMPONENT

(75) Inventors: Makoto OGAWA, Nagaokakyo-shi (JP); Akihiro MOTOKI, Nagaokakyo-shi (JP); Atsuko SAITO, Nagaokakyo-shi (JP); Kenji MASUKO, Nagaokakyo-shi (JP); Toshinobu FUJIWARA, Nagaokakyo-shi (JP)

(73) Assignee: MURATA MANUFACTURING CO., LTD., Nagaokakyo-shi (JP)

(21) Appl. No.: 13/456,326

(22) Filed: Apr. 26, 2012

(30) Foreign Application Priority Data
May 13, 2011 (JP) 2011-107956

(51) Int. Cl. B32B 15/01

(52) U.S. Cl. 428/457

(57) ABSTRACT

An electronic component that prevents or minimizes whiskers or has good solder wettability includes a rectangular solid-shaped electronic component element and external electrodes of terminal electrodes provided at opposed end surfaces of the electronic component element. First plated films including Ni are provided on the surfaces of the external electrodes. Second plated films including Sn defining an outermost layer are arranged so as to cover the first plated films. The second plated films have a polycrystalline structure, and flake-shaped Sn—Ni alloy grains are provided at a Sn crystal grain boundary. Intermetallic compound layers including Ni₃Sn₄ are provided at interfaces between the first plated films and the second plated films.

### BACKGROUND OF THE INVENTION

1. Field of the Invention

The present invention relates to an electronic component, and more particularly, to an electronic component including a Sn-plated film, such as a laminated ceramic capacitor.

2. Description of the Related Art

As a background technique for the present invention, for example, International Publication WO2006/134665 discloses a member on which a film including Sn as a main component is formed, a film formation method and a soldering method.

In a terminal for a connector, a lead frame for a semiconductor integrated circuit, and the like, a film is formed on a ground layer formed by Ni-plating or the like using a material having a good solderability. Here, a film is formed by Sn-plating which does not include Pb, instead of plating a Sn—Pb solder which has been conventionally used, in view of environmental concerns. If a Sn-plated film is formed, whisker-like crystals, called whiskers, of Sn tend to develop in the film. When whiskers develop and grow, they may cause a short-circuit between adjacent electrodes. When whiskers separate from a film and scatter, the scattered whiskers may induce a short-circuit inside and outside the equipment.

In the technique disclosed in International Publication WO2006/134665, for the purpose of providing a member having a film which can prevent development of such whiskers, a film having Sn as a main ingredient is formed, and then Ni atoms in the ground layer are caused to diffuse into the crystal grain boundary of Sn by a heat treatment to form an intermetallic compound of Sn and a first metal, such as Ni. The intermetallic compound is formed at the crystal grain boundary of Sn and between the ground layer and the film in the form of a thin leaf (flake) that spreads two-dimensionally.

However, the film disclosed in International Publication WO2006/134665 has an insufficient capability to prevent whiskers. Even at room temperature, flake-shaped metal grains formed at the crystal grain boundary of Sn and including Sn/Ni progressively grow and reach the surface of a film having Sn as a main ingredient to form nickel oxide. The presence of nickel oxide on the surface of a film having Sn as a main ingredient causes a problem of reduced solder wettability.

Thus, there is a desire for an electronic component including as an outermost layer a film including Sn as a main ingredient, such as, for example, a laminated ceramic capacitor, wherein the electronic component includes an electrode which prevents whiskers and does not have deteriorated solder wettability.

### SUMMARY OF THE INVENTION

To overcome the problems described above, preferred embodiments of the present invention provide an electronic component including an electrode which prevents or minimizes whiskers and has good solder wettability.

A preferred embodiment of the present invention provides an electronic component preferably including a Ni-plated film and a Sn-plated film provided on the Ni-plated film, wherein the Sn-plated film has a Sn polycrystalline structure, Ni/Sn alloy grains having a Ni content ratio of about 10 mol % to about 20 mol % and a Sn content ratio of about 80 mol % to about 90 mol % are provided at a Sn crystal grain boundary of the Sn-plated film, and an intermetallic compound layer including Ni₃Sn₄ is provided at an interface between the Sn-plated film and the Ni-plated film.

In such an electronic component, the intermetallic compound layer is preferably arranged so as to cover, for example, about 95% by area or more of the surface of the Ni-plated film.

In the electronic component according to a preferred embodiment of the present invention, flake-shaped Ni/Sn alloy grains having the abovementioned Ni/Sn content ratio are preferably provided at the Sn crystal grain boundary in the Sn-plated film of the electronic component, so that even if the movement of Sn atoms from Sn crystal grains to the Sn crystal grain boundary is prevented and whiskers develop at the Sn crystal grain boundary, their growth is prevented or minimized. Further, the intermetallic compound layer including Ni₃Sn₄ is preferably provided between the Sn-plated film and the Ni-plated film, whereby diffusion of Ni from the Ni-plated film to the Sn-plated film is prevented and flake-shaped Sn/Ni alloy grains at the Sn crystal grain boundary no longer grow. Therefore, flake-shaped Sn/Ni alloy grains are prevented from reaching the surface of the Sn-plated film, so that good solder wettability of the Sn-plated film is maintained.

To prevent diffusion of Ni from the Ni-plated film to the Sn-plated film in order to stop growth of flake-shaped Sn/Ni alloy grains at the Sn crystal grain boundary in this manner, the intermetallic compound layer including Ni₃Sn₄ preferably covers at least about 95% by area of the surface of the Ni film, for example.

According to various preferred embodiments of the present invention, an electronic component includes an electrode which prevents or minimizes whiskers and maintains good solder wettability.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional schematic view showing a laminated ceramic capacitor according to a preferred embodiment of the present invention.

FIG. 2 is an electron photomicrographic image of a cross section cut along the direction of stacking of a first plated film and a second plated film in a laminated ceramic capacitor shown in FIG. 1.

FIG. 3 is an electron photomicrographic image of the surface of an intermetallic compound layer after removing the second-plated film that is the outermost layer in the laminated ceramic capacitor shown in FIG. 1.

### DETAILED DESCRIPTION OF THE PREFERRED EMBODIMENTS

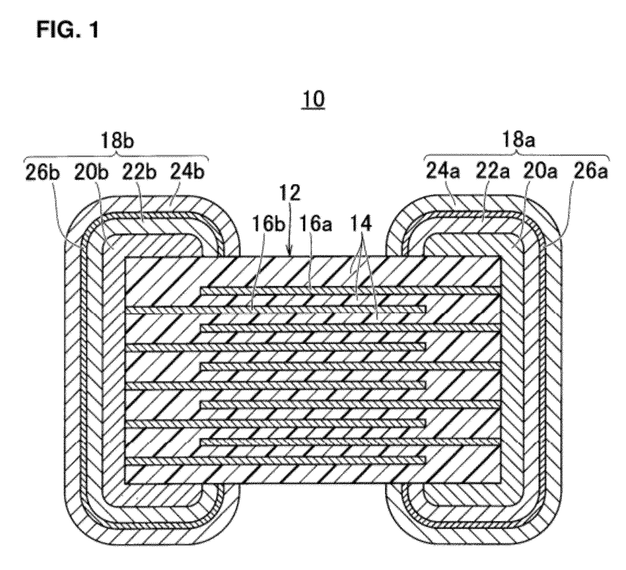

FIG. 1 is a cross-sectional schematic view showing a laminated ceramic capacitor according to a preferred embodiment of the present invention.

A laminated ceramic capacitor 10 shown in FIG. 1 preferably includes a rectangular or substantially rectangular solid-shaped ceramic element 12. The ceramic element 12 includes multiple ceramic layers 14 preferably including, for example, a barium titanate-based dielectric ceramic as a dielectric. The ceramic layers 14 are stacked, and internal electrodes 16a and 16b preferably including, for example, Ni are alternately arranged among the ceramic layers 14.

In this case, the internal electrode 16a is arranged such that one end extends to one end of the ceramic element 12. The internal electrode 16b is arranged such that one end extends to the other end of the ceramic element 12.

Further, the internal electrodes 16a and 16b are arranged such that the middle portion and the other ends thereof overlap each other with one of the ceramic layers 14 interposed therebetween. Thus, the ceramic element 12 has a laminated structure in which a plurality of internal electrodes 16a and 16b are provided with ceramic layers 14 interposed therebetween.

At one end surface of the ceramic element 12, a terminal electrode 18a is provided so as to be connected to the internal electrode 16a. Similarly, at the other end surface of the ceramic element 12, a terminal electrode 18b is provided so as to be connected to the internal electrode 16b.

The terminal electrode 18a preferably includes an external electrode 20a including, for example, Cu. The external electrode 20a is provided at one end surface of the ceramic element 12 so as to be connected to the internal electrode 16a. Similarly, the terminal electrode 18b includes an external electrode 20b preferably including, for example, Cu. The external electrode 20b is provided at the other end surface of the ceramic element 12 so as to be connected to the internal electrode 16b.

On the surfaces of the external electrodes 20a and 20b, first plated films 22a and 22b preferably including Ni, for example, to prevent solder leach, are provided as Ni-plated films, respectively.

As a Sn-plated film as an outermost layer, second plated films 24a and 24b preferably including Sn to improve solderability are arranged so as to cover the first plated films 22a and 22b, respectively. The second plated films 24a and 24b each preferably have a Sn polycrystalline structure, and Sn/Ni alloy grains are preferably provided at the Sn crystal grain boundary. In this case, the Sn/Ni alloy grain of the Ni/Sn alloy layer is flake-shaped. Further, in the second plated films 24a and 24b, flake-shaped Ni/Sn alloy grains may preferably be provided within a Sn crystal grain. In this case, the second plated films 24a and 24b each preferably have 3 or more flake-shaped Sn—Ni alloy grains on average within one Sn crystal grain, in the Sn crystal grain contacting one of the first plated films 22a and 22b including Ni. The flake-shaped Ni/Sn alloy grain is preferably made of a Ni/Sn alloy having a Ni content ratio of about 10 mol % to about 20 mol % and a Sn content ratio of about 80 mol % to about 90 mol %, for example.

Intermetallic compound layers 26a and 26b including Ni₃Sn₄, for example, are preferably provided at interfaces between the first plated films 22a and 22b and the second plated films 24a and 24b. The intermetallic compound layers 26a and 26b are preferably arranged so as to cover, for example, about 95% by area of the surfaces of the first plated films 22a and 22b, respectively.

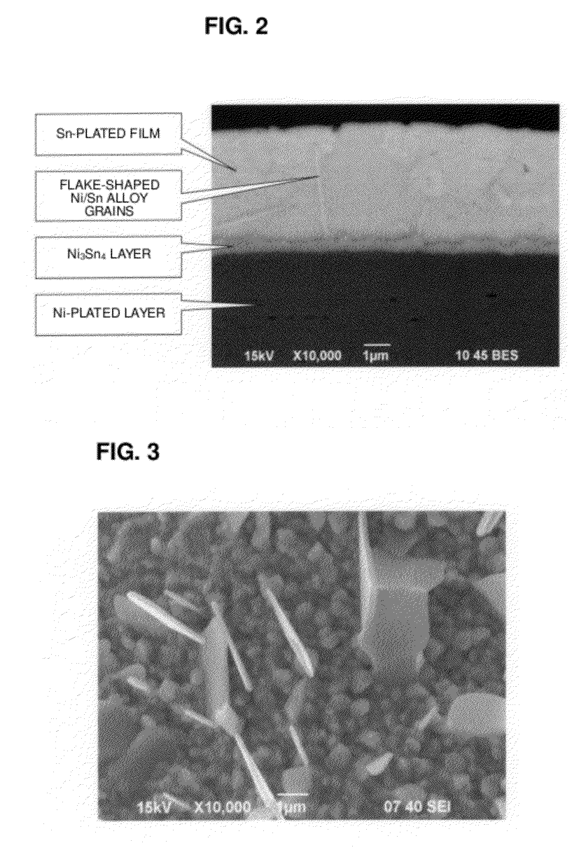

FIG. 2 shows an electron photomicrographic image of a cross section cut along the direction of stacking of the first plated film and the second plated film. FIG. 3 is an electron photomicrographic image of a surface after dissolving and removing the second plated film that is the outermost layer.

One example of a method of producing the laminated ceramic capacitor 10 shown in FIG. 1 will now be described.

First, a ceramic green sheet, a conductive paste for an internal electrode, and a conductive paste for an external electrode are prepared. The ceramic green sheet and the conductive pastes include binders and solvents, and known organic binders and organic solvents may preferably be used.

Next, the conductive paste for an internal electrode is printed onto the ceramic green sheet in a predetermined pattern by, for example, screen printing to form an internal electrode pattern.

A predetermined number of ceramic green sheets for an outer layer on which no internal electrode pattern is printed are stacked, ceramic green sheets on which an internal electrode pattern is printed are stacked thereon one after another, and a predetermined number of ceramic green sheets for an outer layer are stacked thereon to thereby provide a mother laminate.

Subsequently, the mother laminate is pressed in the stacking direction using, for example, a hydrostatic pressure press.

The pressed mother laminate is cut into a predetermined size and a raw ceramic laminate is cut out. At this time, corners and edges of the raw ceramic laminate may be rounded, for example, by barrel polishing or other suitable method.

Subsequently, the raw ceramic is fired. In this case, the firing temperature depends on the materials of the ceramic layer 14 and internal electrodes 16a and 16b, but is preferably about 900° C. to about 1300° C., for example. The ceramic laminate after firing is a ceramic element 12 including the ceramic layer 14 of the laminated ceramic capacitor 10 and internal electrodes 16a and 16b.

The conductive paste for an external electrode is coated on the opposite ends of the ceramic laminate after firing, and baked to thereby form external electrodes 20a and 20b of terminal electrodes 18a and 18b.

Subsequently, on the surfaces of the first external electrode 20a and the second external electrode 20b, first plated films 22a and 22b are preferably formed, respectively, by plating Ni, for example.

On the surfaces of the first plated films 22a and 22b, second plated films 24a and 24b are formed, respectively, preferably by plating a metal including Sn, for example, and performing a heat treatment. In this case, on the surfaces of the first plated films 22a and 22b, second plated films 24a and 24b having flake-shaped Ni/Sn alloy grains are preferably formed by, for example, plating Sn and performing a heat treatment at a relatively low temperature for a relatively long period of time.

Next, the ceramic element 12 including the first plated films 22a and 22b and the second plated films 24a and 24b formed thereon are subjected to a heat treatment at a relatively high temperature for a relatively short time, whereby intermetallic compound layers 26a and 26b including Ni₃Sn₄ are formed at interfaces between the first plated films 22a and 22b and the second plated films 24a and 24b.

The laminated ceramic capacitor 10 shown in FIG. 1 is produced in the manner described above.

In the laminated ceramic capacitor 10 shown in FIG. 1, preferably, the second plated films 24a and 24b as outermost layers each have a Sn polycrystalline structure and flake-shaped Ni/Sn alloy grains are formed at the Sn crystal grain boundary, so that even if the movement of Sn atoms from Sn crystal grains to the Sn crystal grain boundary is hindered and whiskers develop at the Sn crystal grain boundary, their growth is prevented or minimized. Particularly, by forming flake-shaped Ni/Sn alloy grains not only at the Sn crystal grain boundary but also within the Sn crystal grain, compression stresses in the second plated film are reduced, initial points at which whiskers develop are decentralized, and energy for the development of whiskers decreases. Thus, in the laminated ceramic capacitor 10, a short circuit caused by whiskers is effectively prevented.

The laminated ceramic capacitor 10 shown in FIG. 1 has good solderability since the second plated films 24a and 24b as outermost layers are each formed of Sn.

Further, in the laminated ceramic capacitor 10 shown in FIG. 1, solder leaching is prevented due to the first plated films 22a and 22b being formed of Ni.

In the laminated ceramic capacitor 10, the intermetallic compound layers 26a and 26b including Ni₃Sn₄ are preferably formed at interfaces between the first plated films 22a and 22b and the second plated films 24a and 24b, so that diffusion of Ni atoms from the first plated films 22a and 22b to the second plated films 24a and 24b is prevented. Consequently, the flake-shaped Ni/Sn alloy grains formed in the second plated films 24a and 24b are prevented from growing and no longer reach the surfaces of the second plated films 24a and 24b, and thus, good solder wettability of the second plated films 24a and 24b is maintained.

Further, the laminated ceramic capacitor 10 shown in FIG. 1 is also environmentally safe since Pb is not used in the first plated films 22a and 22b, the second plated films 24a and 24b, and so on.

### Experimental Example

In the Experimental Example, laminated ceramic capacitors of an Example 1 and Comparative Examples 1 and 2 shown below were produced, and whiskers in films and solder wettability of terminal electrodes were evaluated for those laminated ceramic capacitors.

### Example 1

In Example 1, the laminated ceramic capacitor 10 shown in FIG. 1 was produced by the abovementioned method. In this case, the outside dimensions of the laminated ceramic capacitor 10 were about 2.0 mm (length)×about 1.25 mm (width)×about 1.25 mm (height). A barium titanate-based dielectric ceramic was used as a ceramic layer 14 (dielectric ceramic). Further, Ni was used as a material for the internal electrodes 16a and 16b. Further, Cu was used as a material for the external electrodes 20a and 20b.

In Example 1, first plated films 22a and 22b and second plated films 24a and 24b were formed under the following conditions.

### (1) Plating Bath

Plating bath for forming the first plated film: a Ni bath generally called a Watts bath was used.

Plating bath for forming the second plated film: a weak acid Sn plating bath (citric acid-based weak acid bath) with sulfate as a metal salt, citric acid as a complexing agent and one or both of a quaternary ammonium salt and a surfactant containing an alkyl betaine as a gloss agent was used.

### (2) Current Density and Current Passage Time

First plated film: the current passage time was controlled by current density Dk=2.0 [A/dm²] so that the film could be formed with a thickness of about 5 μm.

Second plated film: the current passage time was controlled by current density Dk=1.0 [A/dm²] so that the film could be formed with a thickness of about 5 μm.

After forming second plated films 24a and 24b, the films were dried in air at about 80° C. for about 15 minutes.

### (3) Plating Technique

Plating technique for forming first plated film and second plated film: a rotation barrel having a drum volume of about 300 cc and a diameter of about 70 mm was used. Here, using about 40 ml of balls (material: Sn) having a diameter of about 0.7 mm as a medium and nylon-coated iron balls having a diameter of about 8.0 mm as stirring balls, a plated film was formed with a chip charge of about 20 ml and a barrel rotation speed of about 20 rpm.

Further, for forming flake-shaped Ni/Sn alloy grains on second plated films 24a and 24b, Ni was plated on the surfaces of external electrodes 20a and 20b as first plated films 22a and 22b, Sn was plated on the surfaces of Ni-plated films as second plated films 24a and 24b, and a heat treatment was performed at about 40° C. for about 200 days.

Flake-shaped Ni/Sn alloy grains were formed on the second plated films 24a and 24b, followed by performing a heat treatment at about 160° C. for about 30 minutes to form intermetallic compound layers 26a and 26b including Ni₃Sn₄ at interfaces between the first plated films 22a and 22b and the second plated films 24a and 24b.

After each plating treatment, the resultant plated film was washed using pure water.

### Comparative Example 1

In Comparative Example 1, Ni-plated films (first plated films) and Sn-plated films (second plated films) were formed as in Example 1, but a heat treatment at about 160° C. for about 30 minutes was not performed. Therefore, flake-shaped Ni/Sn alloy grains are formed in the second plated films, but intermetallic compound layers 26a and 26b including Ni₃Sn₄ are not formed at interfaces between first plated films 22a and 22b and second plated films 24a and 24b.

### Comparative Example 2

In Comparative Example 2, Ni-plated films (first plated films) and Sn-plated films (second plated films) were formed as in Example 1, but a heat treatment at about 40° C. for about 200 days was not performed. Therefore, flake-shaped Ni/Sn alloy grains are not formed in the second plated films, but intermetallic compound layers 26a and 26b including Ni₃Sn₄ are formed at interfaces between first plated films 22a and 22b and second plated films 24a and 24b.

Next, whiskers in the film were evaluated in accordance with the JEDEC standard shown below for the laminated ceramic capacitors of Example 1 and Comparative Examples 1 and 2.

Number of samples (n): 3 lots×6/lot=18.

Test conditions: the sample is held at about −55° C. (+0° C./−10° C.) as a minimum temperature and about 85° C. (+10° C./−0° C.) as a maximum temperature for about 10 minutes, respectively, and given 1500 cycles of thermal shock in a gas phase.

Observation: observations are made by a 1000× electron photomicrographic image using a scanning electron microscope (SEM).

Criterion: Class 2 (infrastructure equipment for communication, automobile equipment) was applied, and samples with the maximum length (straight line length) of whiskers being less than about 45 μm were designated as G (good) and samples with the maximum length (straight line length) of whiskers being about 45 μm or greater were designated as NG (poor).

Whiskers were evaluated for presence and absence of a reflow treatment after the plating treatment. The reflow treatment was performed by maintaining the prepared laminated ceramic capacitor at a maximum temperature of about 260° C. for about 2 minutes. By performing the reflow treatment, the Sn-plated film was melted to remove stresses (strains) during plating.

For the laminated ceramic capacitors of Example 1 and Comparative Examples 1 and 2, solder wettability was evaluated by a solder checker (SAT-5000 manufactured by Rheska Corporation). Evaluation conditions are as follows: number of samples: 10, solder microsphere method, solder class: M 705, temperature: about 245° C. and flux C (rosin-ethanol).

In this test, samples with an average of zero cross time being about 2 seconds or less were designated as G (good) and samples with an average of zero cross time being greater than about 2 seconds were designated as NG (poor). The results obtained are shown in Table 1.

TABLE 1

| | Maximum | Maximum | Evaluation | Evaluation |
|---|---|---|---|---|
| | whisker length | whisker length | for | for solder |
| Samples | (reflow absent) | (reflow present) | whiskers | wettability |
| Example 1 | 35 μm | 30 μm | G | G |
| Comparative | 30 μm | 28 μm | G | NG |
| Example 1 | | | | |
| Comparative | 60 μm | 50 μm | NG | G |
| Example 2 | | | | |

As a result, for Example 1, the whisker maximum length was good with the whisker maximum length being about 35 μm when the reflow treatment was absent and the whisker maximum length being about 30 μm when the reflow treatment was present. Evaluation of solder wettability also showed good results.

On the other hand, for Comparative Example 1, the whisker maximum length was good with the whisker maximum length being about 30 μm when the reflow treatment was absent and the whisker maximum length being about 28 μm when the reflow treatment was present, but the solder wettability was poor due the absence of an intermetallic compound layer including Ni₃Sn₄. For Comparative Example 1, solder wettability exceeded the evaluation criterion and was therefore evaluated as poor, but was not unacceptable in actual use.

For Comparative Example 2, the whisker maximum length was poor with the whisker maximum length being about 60 μm when the reflow treatment was absent and the whisker maximum length being about 50 μm when the reflow treatment was present. However, since no flake-shaped Ni/Sn alloy grains were formed in the second plated film, Ni/Sn alloy grains did not reach the surface of the second plated film, and good solder wettability was obtained.

Thus, it can be understood that the length of whiskers increases if Ni/Sn alloy grains are not formed in the second plated film, and the solder wettability of the second plated film is degraded if an intermetallic compound layer including Ni₃Sn₄ is not formed at an interface between the first plated film and the second plated film. In contrast, in Example 1, the length of whiskers is short and the solder wettability of the second film is good.

The thickness of each of the first plated films 22a and 22b has been found to have no influences on whiskers as long as the underlying external electrodes 20a and 20b can be covered, and any thickness of about 1 μm or greater is applicable.

The thickness of about 5 μm with which whiskers most easily grow was selected as a preferable thickness of each of the second plated films 24a and 24b, but it has been found that whiskers could be prevented with a thickness in the range of about 1 μm to about 10 μm.

In the preferred embodiments described above, a barium titanate-based dielectric ceramic is preferably used as a dielectric material. However, for example, a calcium titanate-based, strontium titanate-based or calcium zirconate-based dielectric ceramic may also be used. As a ceramic material of the ceramic layer 14, one incorporating an accessory ingredient, such as a Mn compound, a Mg compound, a Si compound, a Co compound, a Ni compound or a rare earth compound, for example, may be used.

In the preferred embodiments described above, Ni is preferably used as an internal electrode. However, for example, Cu, Ag, Pd, an Ag—Pd alloy, Au or other suitable materials may be used.

In the preferred embodiments described above, Cu is preferably used as an external electrode. However, for example, one selected from the group consisting of Ag and Ag/Pd or an alloy containing such metals may be used.

The electronic component according to preferred embodiments of the present invention is suitably used particularly for electronic components such as, for example, laminated ceramic capacitors which are densely mounted.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electronic component comprising:
a Ni-plated film; and
a Sn-plated film provided on the Ni-plated film; wherein
the Sn-plated film has a Sn polycrystalline structure;
Ni/Sn alloy grains having a Ni content ratio of about 10 mol % to about 20 mol % and a Sn content ratio of about 80 mol % to about 90 mol % are provided at a Sn crystal grain boundary of the Sn-plated film; and
an intermetallic compound layer including Ni₃Sn₄ is provided at an interface between the Sn-plated film and the Ni-plated film.

2. The electronic component according to claim 1, wherein the intermetallic compound layer is arranged to cover about 95% by area of the surface of the Ni-plated film.
